(19) United States
(12) Patent Application Publication
(10) Pub. No.: US 2004/0265439 A1
(43) Pub. Date: Dec. 30, 2004

(54) Edible protein matrix and method for making the same

(75) Inventor: David W. Galloway, Mercer Island, WA (US)

Correspondence Address: Mr. Stephen M. Evans, GRAYBEAL JACKSON HALEY LLP, Suite 350, 155 - 108th Avenue NE, Bellevue, WA, 98004-5901, US

(73) Assignee: Premier Pacific Seafoods

(21) Appl. No.: 10/811,452

(22) Filed: Mar. 26, 2004

Related U.S. Application Data
(63) Continuation of application No. PCT/US01/30184, filed on Sep. 26, 2001.

(51) Int. Cl. A23C 9/12

(52) U.S. Cl. 426/135

(57) ABSTRACT

An intermediary edible composition of a protein emulsion that can be formed into intermediary films for construction of sheets and pockets, and into extruded forms is disclosed. The emulsion preferably includes a fish-based protein and is used to create intermediary films, which are laid in convex mold halves (FIG. 1). The molds are mated and subjected to a heating step where after a protein-based pocket structure is formed. The pocket can be used for holding a variety of foodstuffs, and has excellent moisture absorption resistance as well as mechanical properties.

### BACKGROUND OF THE INVENTION

1. Field of the Invention

The invention relates to processed edible food products, and more particularly to edible products obtained from proteins and used, for example, as wraps or pockets for other foodstuffs.

2. Description of the Prior Art

Food coverings such as pockets and wraps are well known. Examples include things from tortillas and pitas to ice cream cones, rolls (sushi, spring rolls, etc.), and dumplings. Therefore, it is well known to envelop one food product with another food product. In particular, carbohydrate-based wraps have been used to envelop protein-based food products. This propensity is based in large part upon the ease in which the pockets and wraps can be constructed as well as formed about the enveloped food products.

Notwithstanding the foregoing, use of carbohydrate based outer layers is not without detractions. For example, prior art outer layers readily absorb water and other fluids. This absorption can result from leaching of fluids from the inner food products or from the outer environment. Prior art outer layers also are not known for their strength and durability.

### SUMMARY OF THE INVENTION

The invention is directed to an edible protein matrix composition, intermediary and final articles such as films and pockets made from such a composition, and methods for making the composition and resultant articles. The protein matrix composition comprises greater than 50% processed protein by weight and greater than 25% water by weight. The protein can be obtained from mammalian, avian, reptilian, or aquatic sources. Intermediary and final films produced according to the invention range from 1 mm to 4 mm, and preferably are between 2 mm and 3 mm.

In a preferred embodiment, an aquatic source of protein such as Alaskan Pollock, Pacific Whiting, Cod, Halibut, or other white fleshed fish meat, preferably in the form of ground meat “surimi” is used. Specific species and grades of “surimi” may be used singularly or blended together in combinations of two or more types. The intermediary composition preferably comprises greater than 50% surimi by weight, and is processed in conjunction with water and variable amounts of suitable additives such as plant carbohydrates, spices, gums and oils.

The composition resulting from the above-referenced processing is preferably used to form intermediary surimi films having a sectional thickness of between 2 mm and 3 mm, which can subsequently be processed to form pockets or envelopes for surrounding other edible food products. The intermediary surimi films can either be cured with or without the edible food products, but are preferably cured prior to or during formation of the pocket or envelope. The intermediary surimi films can either be folded to produce the desired pocket or envelope, or the pocket or envelope can be formed from two films that are joined together prior to or during the cure process. In either case, the intermediary surimi film(s) is/are preferably mated under pressure at the attachment points during curing of the film(s).

A quality of the products resulting from an intermediary protein film beneficially includes high moisture resistance. Unlike carbohydrate-based products that are hydrophilic, products resulting from the intermediary film of the invention are generally hydrophobic. Consequently, high moisture content foodstuffs can be placed in a pocket constructed from the intermediary protein film without noticeable degradation of the pocket. Moreover, another beneficial quality includes good flexibility, and resistance to breakage and spillage. Thus, fillings in the pocket can be packed tightly without as great a risk of tearing, leaking, or popping open as would be true with carbohydrate-based films. In addition, the products resulting from the intermediary films of the invention form protein and hydrocolloidal matrices that are resistant to moisture and flavor transmissions. Therefore, high flavor foodstuffs can be disposed into a pocket, for example, with minimal loss of flavor over time.

The films and other products according to the invention can be further processed to include selected surface treatments, flavor modifications, and aesthetic treatments. Surface treatments include mold-induced texturing and adjunct incorporation (this treatment includes, for example, breading, particulates such as seeds, flavorings, and colorings); flavor modifications include spices, oils, artifical and natural flavors and seasonings whether incorporated into the matrix or applied as a surface treatment; aesthetic treatments include any process that modifies the visual appearance of the film such as grill marks, broiling, frying and molding, whether incorporated into the matrix or applied as a surface treatment.

By substituting a protein-based component for a traditionally starch-based component in forming a sheet or pocket, a consumer has the option of creating entirely new eating experiences insofar as the consumer may now integrate protein food stuffs into a meal whose major constituent has traditionally been non-protein, e.g., pastas, breads, tortillas and other similar products.

These and other aspects of the invention will be further appreciated by inspection of the accompanying drawing and description.

### BRIEF DESCRIPTION OF THE DRAWINGS

FIG. 1 is an illustrative lay up of four molds (mirror image molds not shown) for creating a pocket embodiment employing films of the invention.

### DESCRIPTION OF THE PREFERRED EMBODIMENTS

The following discussion is presented to enable a person skilled in the art to make and use the invention. Various modifications to the preferred embodiment will be readily apparent to those skilled in the art, and the generic principles herein may be applied to other embodiments and applications without departing from the spirit and scope of the present invention as defined by the appended claims. Thus, the present invention is not intended to be limited to the embodiment show, but is to be accorded the widest scope consistent with the principles and features disclosed herein.

A preferred protein matrix composition according to the invention is obtained from a mixture of various grades of surimi, water, potato starch, soy oil, salt, and calcium as set forth below.

| Ingredient | Percent Weight of Ingredient |
|---|---|
| Surimi SA | 26.2% |
| Surimi FA | 30.6% |
| Surimi A | 8.7% |
| Salt | 1.6% |
| Potato Starch | 3.5% |
| Calcium | 0.9% |
| Soy Oil | 2.2% |
| Water | 27.0% |

The constituents listed above are representative of one formulation. Other grades and ratios of surimi, types of starch and array of additives can also produce compositions of acceptable character using the following preparation and processes:

Creation of Protein Matrix Composition: Surimi ingredients of various grades are selected based on rheological properties to yield an average gel strength of between 850 and 1000 grams per centimeter as measured by using a penetrometer with a 5 millimeter probe and rate of travel of 60 millimeters per minute on prepared samples. After selection of the surimi, frozen surimi blocks are adjusted to a core temperature of between −3.9° and −3.3° C. prior to beginning the blending process. The tempered surimi is then chopped to a fine consistency in a vacuum bowl or vertical chopping machine until a temperature of −1.1° to −0.6° C. is reached. Salt is added and chopping continues until a temperature of 0° C. is obtained. Any remaining ingredients and water are then added and a vacuum of −1 bar is drawn on the chopping and mixing chamber as mixing continues with a high (greater than 3000 rpm) blade speed until the temperature reaches 7.2° to 12.8° C. This effectively emulsifies the mixture.

As an alternative, if soy protein isolate is utilized, a separate emulsifying step of combining soy isolate, water and oil may be included. This process involves hydrating soy protein isolate and subsequently slowly emulsifying soy oil to form a curd, which is chilled and added as a separate ingredient to the process described above.

Creation of Protein Matrix Films: Once the intermediary composition has been obtained, it may be further processed into a variety of desired forms. In a preferred embodiment, surimi films are created from the composition. Using the above-described composition, the surimi emulsion is transferred by appropriate pump action from the chopper to an extrusion nozzle by a vacuum delivery system that reduces or eliminates air inclusion. A cooling system to maintain the emulsion temperature at or below 10° C. is also incorporated. It is to be understood that the method for producing films from the intermediary protein composition is not significantly dependent on the nature of the protein. Therefore, those persons skilled in the art will appreciate that minor modifications to the extrusion parameters may be necessary to create a desired film.

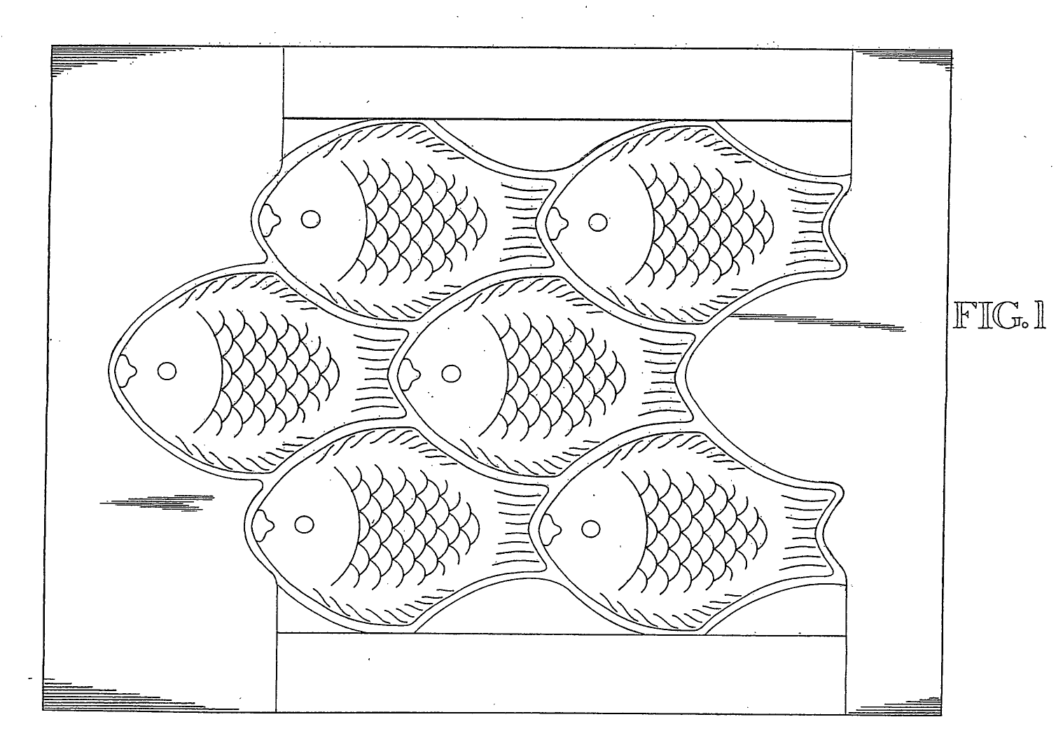

In a preferred embodiment, a fanciful pocket is formed from two mold plates over which sheets of the resultant intermediate surimi film has been extruded. As depicted in FIG. 1, a pair of contoured mold plates (one being shown) are used to form the desired pocket. As the intermediary surimi film is laid over a corresponding mold plate, it is permitted to sag so as to fully contact the interior surface thereof. After extrusion onto the molds, the intermediate surimi film undergoes an initial preset step. While the environment and duration of exposure for preset varies depending upon the composition of the intermediary surimi film and the processing environment, if the above-described composition is chosen, the plates are exposed to an environment of 32.2° C. and 1 bar for approximately 15 minutes. This preset step increases the elasticity, flexibility and strength of the final product.

Once the initial preset period has elapsed, the molds are mated together and the assembly is subjected to a heating process to cure and cook the films and contacting areas. In a preferred embodiment, the plates are subjected to a temperature of approximately 93.3° C. for about 15 minutes. Upon separation of the molds, the final product is available.

Once the final product is obtained, it may be necessary to trim excess film material from adjacent each pocket, depending upon the type of molds used. Further modification of the resulting product by applying grill marks, broiling, frying or topical coatings of seeds, starch, seasonings or spices may be desirable for specific markets.

A significant reason for the development of the invention disclosed herein was to provide consumers with an alternative to traditional starch-based pocket foods. Having obtained a protein-based pocket, which beneficially has low moisture absorptive properties, it is possible to incorporate into the resultant pocket a myriad of foods. Consequently, it is within the scope of the invention to create an end-user product that comprises an edible protein matrix film that has been formed into a receptacle and filled with another type of food stuff.

It is also contemplated to form other products from the intermediary other than films. For example, it is considered within the scope of the invention to extrude the emulsions into other pocket style shapes.

What is claimed:

1. An edible protein matrix for use in creating edible compositions comprising:
an intermediary film having greater than 50% processed protein by weight.

2. The matrix of claim 1 wherein the processed protein is derived from a source selected from the group consisting of a non-synthetic mammalian, avian, reptilian, or aquatic protein.

3. The matrix of claim 1 wherein the intermediary film comprises water in excess of 25% by weight.

4. The matrix of claim 1 wherein the intermediary film further comprises a starch.

5. The matrix of claim 1 wherein the intermediary film further comprises an oil.

6. The matrix of claim 1 wherein the intermediary film further comprises a surface adjunct for modifying the surface characteristics of the film.

7. The matrix of claim 1 wherein the protein of the intermediary film has an average gel strength of between about 850 and 1000 g/cm, inclusive.

8. The matrix of claim 1 wherein the intermediary film is folded upon itself and selected portions thereof bonded to one another to form an enveloping structure to retain objects placed therein.

9. The matrix of claim 1 wherein two intermediary films are opposed to each other and selected portions thereof bonded to one another to form an enveloping structure to retain objects placed therein.

10. The matrix of claim 1 wherein the processed protein is surimi.

11. A method for producing an edible protein matrix extrusion comprising:
a) combining a protein derived from a source selected from the group consisting of a non-synthetic mammalian, avian, reptilian, or aquatic proteinwith water to form a composition;
b) blending the composition to form an emulsion; and
c) forming an extrusion from the emulsion.

12. The method of claim 11 wherein the extrusion is a film having nominal thickness from about 1 to 4 mm, inclusive.

13. The method of claim 11 wherein the composition further comprises an additive selected from the group consisting of a salt, a starch, a mineral, and an oil in a percentage by weight that is less than 10% of the protein percentage by weight.

14. The method of claim 11 wherein the composition comprises at least 50% protein by weight.

15. The method of claim 12 further comprising
d) placing the film over first and second concave mold plates;
a) permitting the film over each mold plate to sag, thereby complementing inner surface contours of each mold plate;
f) subjecting the mated mold plates to an initial preset at a first temperature T₁ for a first period of timet₁;
g) mating the first mold plate to the second mold plate so as to form an envelope;
h) subjecting the mated mold plates to a cure at a second temperature T₂for a second period of time t₂; and
i) removing the edible protein matrix envelope.

16. The method of claim 15 wherein the T₂≧T₁.

17. The method of claim 15 wherein 20° C. ≦T₁≦40° C.

18. The method of claim 15 wherein 80° C. ≦T₂≦100° C.

19. The method of claim 15 wherein the film is formed into first and second portions, and the first portion is overlaid the first mold plate and the second portion is overlaid the second mold plate.

20. An edible protein matrix envelope for receiving additional foodstuffs comprising:
a first uncured film having greater than 50% processed protein by weight; a second uncured film having greater than 50% processed protein by weight wherein the first film and the second film are bonded to each other about a pre-established periphery during subsequent curing to form an envelope.

21. The envelope of claim 20 wherein the first film and the second film are portions of a single film.

22. The envelope of claim 20 wherein a portion of the pre-established periphery between the first and the second film is not bonded, to form an opening into the envelope.

23. The envelope of claim 20 wherein the processed protein is selected from the group consisting of a non-synthetic mammalian, avian, reptilian, or aquatic protein.
